(19) United States
(12) Patent Application Publication
(10) Pub. No.: US 2023/0281638 A1
(43) Pub. Date: Sep. 7, 2023

(54) DECENTRALIZED SERVICES PLATFORM

(71) Applicant: Hewlett Packard Enterprise Development LP, Houston, TX (US)

(72) Inventors: Sebastian Kaiser, Ratingen (DE); Marcus Friedrich, Boeblingen (DE); Hartmut Schultze, Ratingen (DE); Florian Buehr, Boeblingen (DE)

(21) Appl. No.: 17/688,353

(22) Filed: Mar. 7, 2022

(51) Int. Cl. G06Q 30/00; G06N 5/04

(52) U.S. Cl. CPC G06Q 30/018; G06N 5/043; G06Q 2220/00

(57) ABSTRACT

Decentralized digital services platforms are described. A system can include a distributed ledger and an orchestration agent. The orchestration agent can function to receive an indication of on offering of a digital asset via a decentralized marketplace. The orchestration agent to initiate communication between the digital asset and one or more service instances. The one or more service instances to utilize the digital asset according to a smart contract stored on the distributed ledger. The orchestration agent can further function to initiate execution of the smart contract to allow the one or more service instances to access the digital asset according to terms of the smart contract, to monitor results and state changes for the one or more service instances during execution of the smart contract, and to append monitoring results to the distributed ledger based on the monitored results and state changes.

### BACKGROUND

Digital assets can be distributed in various clouds, in multiple clouds, in different trust domains, in multiple legal jurisdictions, etc. The ability to provide an ecosystem in which various participants can contract with and utilize the digital assets is a complex and challenging goal.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of one example of a decentralized system stack and corresponding ecosystem.

FIG. 2 is a conceptual diagram of one example of contracting utilizing a marketplace.

FIG. 3 is a conceptual diagram of one example of service instance orchestration in a decentralized ecosystem.

FIG. 4 is a conceptual diagram of one example of service instance coordination in a decentralized ecosystem.

FIG. 5 is a flow diagram for one technique for managing decentralized ecosystem utilizing smart contracts.

FIG. 6 is a block diagram of one example of a processing system that can manage decentralized ecosystem utilizing smart contracts.

### DETAILED DESCRIPTION

The architectures and techniques described herein provide advantageous approaches to providing an ecosystem in which digital assets can be dynamically organized, contracted, monitored and utilized. In a business-to-business (B2B) ecosystem, a distributed, inter-enterprise and/or multi-party ecosystem can be provided that can cross boundaries of legal entities (for the purpose of swarm learning, collaborative data usage, customized processing functionality, etc.), for example.

The example ecosystems described below provide architectures for exchanging workloads using a distributed marketplace environment in which participating entities and offerings (digital assets, for example) are uniquely identifiable within the ecosystem. In some examples, workloads can be exchanged/distributed over boundaries of legal entities having different data privacy/management requirements. The various components of the ecosystems can provide smart contracts in a zero-trust environment while maintaining digital security and privacy. A service agreement lifecycle provided by the ecosystems is based on the smart contracts and further provides service provisioning and end-of-life cleanup. The service agreement lifecycle can further include dispute resolution and/or can enforce dispute resolution penalties based on the smart contracts. This can provide a more efficient contract execution with improved trust and privacy as compared to previous centralized structures.

A “smart contract” is a self-executing contract with the terms of the contract directly included in executable code. The smart contracts are stored using a distributed ledger technology and are executed when predetermined conditions are met. Thus, the smart contract can function to digitally facilitate, verify and enforce the terms of the contract.

The decentralized ecosystems can be a platform-agnostic architectures that can accelerate the contracting and the execution of contract terms as compared to previous approaches. The platform-agnostic functionality can be based on various technologies including Linux processes, container engines, Kubernetes environments and/or any other (including future) technologies, for example.

Many of the examples that follow are particularly useful for use with swarm learning in a B2B setting. However, the swarm learning use case is just one example use case for the ecosystem described and the associated components and advantages of the ecosystem.

In general, “swarm learning” refers to a decentralized machine-learning arrangement utilizing edge computing and distributed ledger-based peer-to-peer networking and coordination of participating entities and digital assets. Swarm learning can provide confidentiality without central coordination, which can result in improvements over more traditional federated learning arrangements. Thus, a B2B swarm learning environment is one in which various participating entities interact within a decentralized ecosystem to provide digital assets and service instances that can be coordinated to provide data analysis and associated functionality.

In some examples, a distributed marketplace can be utilized as part of the coordinating mechanisms. Many inefficiencies in current online marketplace structures are related to risks in terms of trust and information transparency regarding certain capabilities including pricing options, data management, dynamic adjustments and other characteristics, for example. In some environments, when software license agreements (SLAs) are negotiated and formed, a buyer of a digital product/asset may have dynamic needs. In these situations, after the SLA has been enforced by a legally binding contract, some specifics of the SLA may need to be renegotiated, which can result in lengthy contractual discussions and corresponding delays.

Conceptually, the SLA lifecycles can be broken into six stages: 1) service discovery; 2) SLA definition (agreement on metrics, service terms, quality of service (QoS) parameters, etc.); 3) agreement (purchase services including signature, data sharing arrangements, etc.); 4) SLA monitoring (identify SLA violations, monitoring contract execution timeframes, etc.); 5) SLA termination (defined timeout, violation of terms, completion of terms, etc.); and 6) SLA penalty enforcement (pre-defined financial penalties, price reduction, other compensation, etc.), if any.

Most inefficiencies within the SLA lifecycle process regarding contracting and SLA management are related to trust (or lack thereof). In traditional SLA lifecycle management, trust is important when a buyer submits a claim or dispute when an SLA has been violated and evidence must be provided, for example. This part of the process is typically handled by a trusted third party, which introduces additional cost and delay in the process. Further, when a claim is validated, the compensation process requires further delay and possible expense (manual interlocks, for example) for the involved parties.

In the description that follows, systems and approaches that can provide an extendable decentralized ecosystem for contracting, contract execution and policy execution in secure zero-trust computing capsules for multi-party environments are described. The contracting functionality allows different parties from different trust domains to accelerate agreement on collaboration terms in many-to-many relationships between participants, for example. The contract execution functionality can provide federation of trust and orchestration of resources covering terms and conditions, legislation and privacy regulations. Thus, contracted execution refers to execution of the terms of a smart contract by participating entities within an ecosystem.

Policy execution functionality can provide access and authorization to digital assets according to agreements (smart contracts, for example) between the respective contracting parties including the clearance at contract expiration. The ecosystem can ensure accountability by securely and immutably persisting all transactions in a decentralized manner using distributed ledger technologies (DLTs), which are blockchains, directed acyclic graphs (DAGs), hashgraphs, other types of distributed ledgers, etc. DLTs support CREATE and READ functionality (and not UPDATE or DESTROY functionality). CREATE functionality refers to creation of a dataset that can be stored in a database, for example. READ functionality refers to the action of reading or otherwise inspecting a dataset that has been stored in a database, for example. UPDATE functionality refers to updating, replacing or otherwise adjusting data in a dataset. DESTROY functionality refers to deleting or otherwise removing data from a dataset.

A blockchain is a collaboratively maintained list of records (or blocks) that are cryptographically linked (or chained) where the records provide transaction data. Blockchains can be managed in a peer-to-peer manner to function as a distributed ledger. A blockchain can be used to track orders, payments, accounts, smart contracts, etc. A directed acyclic graph is a graph that has vertices and edges with each edge directed from one vertex to another and not directed cycles. A directed acyclic graph is topologically ordered by arranging the vertices as a linear ordering, which can provide chronological transaction record ordering where the transactions can be used to track payments, accounts, smart contracts, etc.

A hashgraph includes a system of individual nodes in a network that share transaction messages to create directed acyclic graphs that time-sequence transactions where each message contains one or more transactions, a timestamp, a digital signature and cryptographic hashes of earlier events. Hashgraphs are based on open source algorithms that are available under the Apache License.

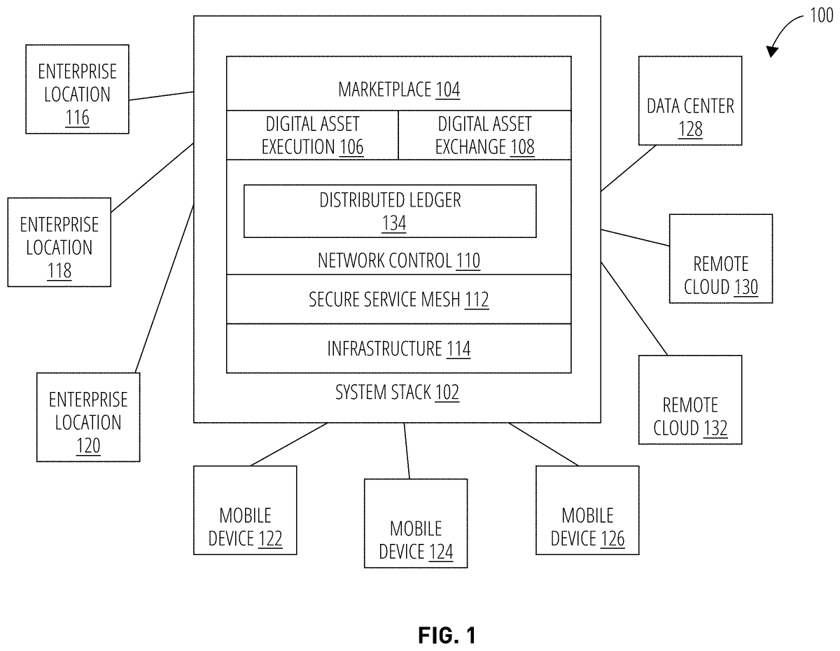

FIG. 1 is a block diagram of one example of a decentralized system stack and corresponding ecosystem. In the example of FIG. 1, digital assets belonging to different participating entities can be distributed at the edge of ecosystem 100, in multiple clouds, in different trust domains and/or corresponding to different legal entities. A digital asset may be software or data (or any combination thereof), for example. A decentralized system utilizing system stack 102 can connect these assets and owning/contracting participants within a digital ecosystem, for example. Within ecosystem 100, participating entities can collaborate, provide and consume digital assets, etc.

In some examples, ecosystem 100 can be decentralized in that no central component is required for any of the individual portions of system stack 102. Further, ecosystem 100 is extendable in that any number of instances can be supported and connected. Thus, any number of participating entities and digital assets can be supported.

Ecosystem 100 can represent, for example, a community of participating entities with a common interest or within a common industry or any other shared characteristic. Multiple ecosystems can exist and operate in parallel. The multiple ecosystems can be interconnected or they can be independent. Various components of system stack 102 are described in greater detail in the figures and descriptions that follow.

In one example, system stack 102 can include marketplace 104, digital asset execution 106, digital asset exchange 108, network control 110, secure service mesh 112 and infrastructure 114. However, as described in greater detail below, not every participating entity is required to use a complete system stack. In an example, system stack 102 is deployed after a smart contract is signed so that the workloads associated with the smart contract can be consumed and/or transferred to other nodes in ecosystem 100.

Participating entities (enterprise locations, mobile devices, remote clouds, data centers, etc.) can offer digital assets to other participating entities via marketplace 104. In some examples, participating entities can host one or more components of system stack 102. Some enterprise locations (enterprise location 116, enterprise location 118, enterprise location 120, etc.) can each host a decentralized marketplace 104 having a listing of one or more digital assets for use by other participating entities while some participating entities (mobile device 122, mobile device 124, mobile device 126, data center 128, remote cloud 130, remote cloud 132, etc.) can provide some, but not all stack components (for example, some participating entitles may not provide a marketplace listing digital assets). Thus, the marketplace functionality of ecosystem 100 is decentralized, in contrast to traditional application store configurations that utilize centralized approaches. Participating entities that provide marketplace functionality have the ability to provide digital assets (a machine learning model, for example) to other entitles within ecosystem 100.

Digital asset execution 106 provides the functionality for participating entities to execute or otherwise utilized digital assets of the ecosystem 100. Digital asset execution 106 can provide processing resources to access or otherwise utilize digital assets according to the terms of a corresponding smart contract. Digital asset execution 106 can provide and/or manage access to processor resources, memory resources, data storage resources and/or other resources that can access or otherwise utilize the digital assets.

Digital asset exchange 108 provides the functionality for participating entities to seek out and acquire digital assets by utilizing one or more marketplaces. Digital asset exchange 108 can provide interconnection and network resources to allow parties to a smart contract to access or otherwise utilize digital assets according to the terms of the smart contract.

Network control 110 can provide network functionality to allow participating entities to interact with each other within ecosystem 100 including network addressing, routing and sending of data packets, etc. Network control 110 can provide distributed ledger technologies to support smart contracts between participating entities of ecosystem 100 including distributed ledger 134, for example. As discussed above, distributed ledger technologies include blockchains, directed acyclic graphs, hashgraphs, other types of distributed ledgers, etc.

Secure service mesh 112 can provide secure services to support secure interactions through network control 110 functionality including traffic management, resiliency, policy enforcement, security enforcement, workload management, etc. Secure service mesh 112 can provide the functionality to secure operations of service instances using the various digital assets within ecosystem 100, for example.

Infrastructure 114 can provide the necessary infrastructure elements to support the functionality of system stack 102 within ecosystem 100 including physical hardware elements that provide the functionality of system stack 102 and associated software/control elements. Infrastructure 114 can include processors, memory devices, racks, power supplies, etc.

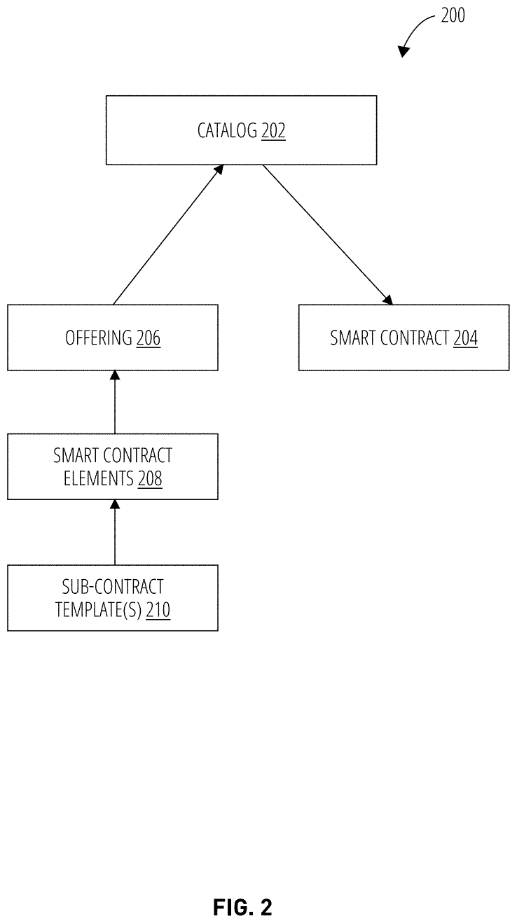

FIG. 2 is a conceptual diagram of one example of contracting utilizing a marketplace. The components and functionality associated with the components of FIG. 2 can be provided via a decentralized marketplace architecture.

Participating entities (enterprise locations, mobile devices, remote clouds, data centers, etc.) and offerings are uniquely identifiable within the ecosystem by being represented as unique digital identities to network control components within the ecosystem. The unique digital identities can be based on one or more underlying attributes of the participating entity or offering to provide a unique set of characteristics that can be the basis of the unique digital identity. The various offerings and collaborations within the ecosystem can be subject to relevant terms and conditions including license, agreements, regulations, policies, etc. These can be generally referred to as “terms” that are associated with (or defined in) a contract between participating entities consuming digital assets (research institutes, artificial intelligence nodes, data analysis organizations, etc.) and participating entities providing digital assets to be consumed.

In the example of FIG. 2, marketplace 200 allows participating entities to offer catalog 202 with associated contracting functionality capable of generating (or contributing to the generation of) one or more smart contract 204. In one example, one or more participating entities can submit offering 206 to catalog 202. Various elements of the ecosystem can register the offering 206 with a unique identifier to a distributed ledger to make offering 206 available to the ecosystem. Participating entities attempting to access digital assets can interact with marketplace 200 to receive an indication of on offering of a digital asset via a decentralized marketplace, the offering having associated smart contract elements.

As part of offering 206, smart contract elements 208 can define terms, contract parameters, restrictions, requirements and/or other elements to be used as a smart contract (or as a part of a smart contract) for offering 206. Smart contract elements 208 can further include one or more sub-contract template(s) 210 that provide additional terms, dependencies, parameters, restrictions and/or digital assets required to execute smart contract 204. Smart contract 204 can be agreed to and executed by participating entities agreeing to exchange offering 206 though catalog 202.

A participating entity interested in offering 206 can agree to the terms specified in smart contract elements 208. With this agreement, smart contract 204 between participating entities (one or more listing/offering participating entities and one or more consuming participating entities, etc.) can be created. Smart contract 204 can include smart contract elements 208 and sub-contract template(s) 210, which may include third parties (independent software vendors, cloud service providers, etc.) as smart contract participants.

The ecosystem architecture does not limit the relation of contracts, sub-contracts and participating entities involved. Thus, the ecosystem architecture can support complex contract situations between multiple participants (owners of data, service providers curating data, organizations analyzing data, organizations utilizing insights generated by data analysis, etc.).

The ecosystem immutably stores smart contract 204 and any subcontracts (sub-contract template(s) 210, for example) on the distributed ledger. Each contract can include smart contracts representing contract terms for automated decentralized contract execution. Sub-contract template(s) 210 can be predefined as part of a contract template (which can include smart contract elements 208) associated with offering 206 and are instantiated as smart contracts upon creation of smart contract 204.

The decentralized ecosystem can execute the smart contracts starting with orchestration of service instances for participating entities involved in the contract execution, for example. In general, orchestration is the process of interacting with one or more providers (through APIs, for example) to provision resources and/or services according to a desired model or structure. As configured in the example of FIG. 1, no central custodian owns or controls the orchestration functionality. In some examples, orchestration is controlled by contracted execution negotiated between collaborating participating entities.

In a swarm learning example, when a participating entity joins a marketplace (or provides a marketplace), that participating entity can then collaboratively train machine learning models together with other participating entities. In swarm learning a participating entity shares parameters via the ecosystem and builds models independently on private data at individual local sites. The ecosystem provides security measures to support data sovereignty, security, and confidentiality realized by private permissioned distributed ledger technologies. Each participant is well defined and only pre-authorized participants can execute transactions and new nodes must satisfy appropriate authorization measures to recognize network participants. A new swarm learning node can enroll via a smart contract, obtain the model, and perform local model training until defined conditions for synchronization are met. Model parameters are exchanged via an application programming interface (API) and merged to create an updated model with updated parameter settings before starting a new training round.

The participating entities could conceptually be considered providing and consuming an algorithm. In another use case example, a second machine learning model can be trained within the same swarm ecosystem or marketplace. A marketplace could provide access to multiple swarm ecosystems a network of hospitals to train various machine learning models together, for example. Offering-related information can be captured as smart contract elements 208. A buyer browsing the marketplace and purchasing offering 206 can provide necessary information to complete smart contract elements 208 and generate smart contract 204.

In an example, offering 206 can be a specific swarm learning ecosystem of participating entities with a common interest in the context of using sensitive health data for training a machine learning model. Offering 206 can include attributes such as length of participation time for one or more participating entities, for example.

As a further example that is based on the participation start date and/or time defined in smart contract 204, the interested participating entity (buyer, consumer, training participant, etc.) is considered participating in the ecosystem in response to executing the smart contract (which can have an associated participation time indicating the length of the contract). Once the participation time is over, the corresponding participating entity can be excluded from the ecosystem based on terms within smart contract 204.

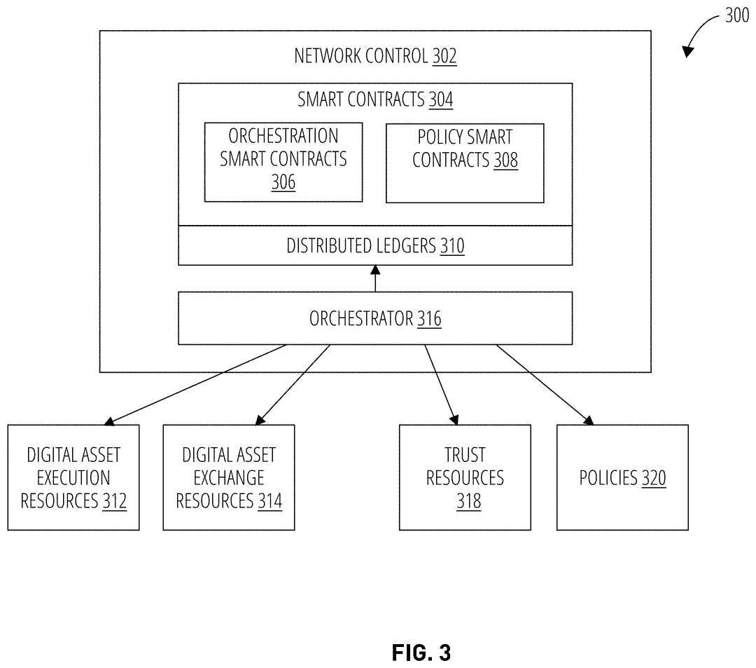

FIG. 3 is a conceptual diagram of one example of service instance orchestration in a decentralized ecosystem. In the example, of FIG. 3, system 300 can exist within a decentralized ecosystem that can execute smart contracts starting with orchestration of service instances for participating entities involved in contract execution, for example. As configured in the example of FIG. 1, no central custodian owns or controls the orchestration functionality. In some examples, orchestration is controlled by contracted execution negotiated between collaborating participating entities.

In one example, network control 302 maintains smart contracts 304, which include orchestration smart contracts 306 and policy smart contracts 308. Network control 302 further maintains distributed ledgers 310. In some examples, network control 302 registers each orchestrated services instance (orchestration smart contracts 306, policy smart contracts 308, etc.) to distributed ledgers 310. Orchestration smart contracts 306 are smart contracts that indicate resources and/or services to be used according to the smart contract terms. Similarly, policy smart contracts 308 are smart contracts that indicate various policies (security level, contract length, etc.) to be applied based on the smart contract terms. Registration of a service can include service endpoints (digital asset execution resources 312, digital asset exchange resources 314, etc.) and relations to the contract and/or relevant participating entities.

Orchestrator 316 can function to federate trust between orchestrated services instances with the context of the contract that they are uniquely related to utilizing trust resources 318 and policies 320, for example. The service instances run in the secure service mesh of the ecosystem. Thus, the service instances can operate on participating entities and/or trust domains of the ecosystem as defined by the contract terms. In some examples, the decentralized ecosystem can securely run digital assets and corresponding service instances in trust domains of other participants based on contract terms.

In the swarm learning example, a participating entity shares parameters via the ecosystem and builds models independently on private data at individual local sites. The participating entity performs local model training until defined conditions for synchronization are met. This can include expansion and/or merging of trust domains, for example. Model parameters are exchanged via an application programming interface (API) and merged to create an updated model with updated parameter settings before starting a new training round.

In one example, during a contract lifecycle, orchestrator 316 functions to at least provision service instances, federate trust and provision policies. Trust can be federated by interconnecting participating entities having equivalent levels of trust and/or authentication. Orchestrator 316 can further function to provide clearance services at the end of the contract period by deconstructing the provisioning performed at the beginning of the smart contract, for example. In one example, orchestrator 316 can further function to log activities (utilizing distributed ledgers 310), for example, provide continuous attestation, enforce access control and/or provide authentication services. Continuous attestation can be provided by ongoing authentication checks and/or security verifications to ensure that the code being executed satisfies the relevant terms and conditions. Data accesses can be monitored to ensure that only authorized participating entities access the digital assets they are authorized to access. Authentication services can be performed on an ongoing basis to verify the identities of the participating entities.

In one example, service instances connecting data and service instances curating data may run at the data source of the participating entity owning the data. Service instances connecting data provide access to data (digital assets) that can be used according to the terms of the corresponding smart contract. Service instances curating data collect/gather data according to the terms of the corresponding smart contract. Service instances analyzing data, which are service instances that provide some analytical functionality (modeling, sorting, pruning, etc.) can also run at the data source of the participating entity owning the data to analyze the data collaboratively in a swarm.

As another example, contract terms may define execution where service instances run in the environment and trust domain corresponding to the participating entities to which they belong. Service instances of the data owner can connect the data to be provided for use by other participating entities, service instances of the curator can gather and/or transfer selected types of data the data, service instances of a research entity (a hospital, a university, a government laboratory, etc.) can initiate transfer of the curated data for analysis. Other configurations that provide combinations of the examples above can also be supported.

Once service instances are orchestrated as part of contract execution, the service instances and digital assets are configured to communicate with each other. In one example, communication between service instances within the ecosystem is based on “mutual authentication” where the functionality of a service instance provides a secure verifiable identity document to each other service instance with which it communicates.

A “verifiable identity document” describes a cryptographically verifiable token encoding the unique identifier of the corresponding service instance. Mutual authentication between two service instances is successful if the secure verifiable identity documents of both are valid and trust between both exists making the secure verifiable identify documents verifiable on each side. Network control 302 and orchestrator 316 can enforce policies 320 from the contract terms and provision policies 320 to orchestrated service instances.

Policies 320 can define the rules of the ecosystem as well as the rules for contract fulfillment. Policies 320 can also include global policies for the ecosystem, geographical policies (local regulations, for example), contract policies and/or clearance policies.

Contract policies can further define what digital assets for curating and/or analysis can be used and which participating entity. In some examples, the ecosystem can securely use digital assets orchestrated as part of a service instance without exposing the content to protect the digital asset of the participating entity that owns the digital asset by allowing the service instance to access the digital assets while restricting the service instance from copying or otherwise using the digital assets beyond the terms of the corresponding smart contract.

Contract policies define the rules for execution, access control and authorization of service instances that collaborate using digital assets. In a swarm learning example, contract policies for connecting data may define what data is allowed to be connected, what data is allowed to be curated and what data is allowed to be analyzed for each participating entity.

Contract policies can further define what digital assets can be curated or analyzed for each participating entity.

Policies 320 can further include rules related to dynamic circumstances of respective activities for which the policy is being enforced. This can include a geographical location of the service instance performing the activity, date, time, consumption rates, etc. Further, more advanced functionalities behavioral analytics of the service instance can be subject to one or more policies, for example.

In a swarm learning example, a participating entity providing a digital asset can participate in training a machine learning model by exposing sensitive data to service instances within the ecosystem. After the training process is complete, weights for the machine learning model can be provided to the swarm (within the ecosystem). Each participating entity can host multiple service instances for connecting data to the machine learning model, local data curation, data analysis, etc. All service instances are uniquely identifiable to the ecosystem and uniquely related to the participating entity providing the digital asset through the contractual relationship. The ecosystem can register each service instance to the distributed ledger of its network control component. The registration of a service instance can include its service endpoints and its unique relationship to the contract as well as to one or more participating entities.

In some examples, components of the ecosystem can continuously attest service instances and the runtime environment. Attestation proves that service instances, runtime environments and digital assets follow to appropriate policies from policies 320 and can be performed on an ongoing basis. Successful attestation of a service instance results in a valid secure verifiable identity document for it to mutually authenticate with other service instances. The ecosystem can enforce policies for all activity of service instances within the ecosystem.

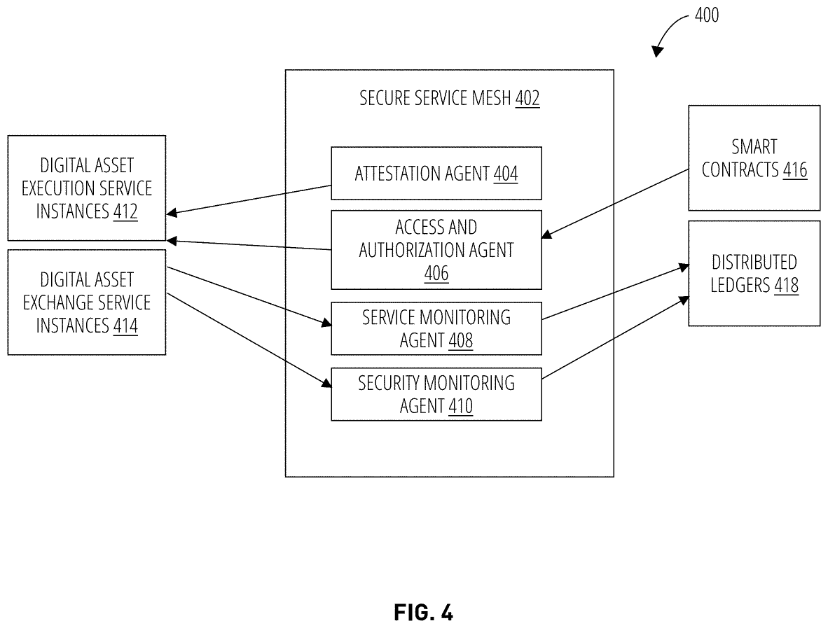

FIG. 4 is a conceptual diagram of one example of service instance coordination in a decentralized ecosystem. In the example of FIG. 4, system 400 can exist within a decentralized ecosystem that can provide full accountability based on the unique identification of participating entities, offerings, contracts and service instances throughout the ecosystem. In some examples, a digital asset can be moved within the ecosystem by service instances from one trust domain to another.

The decentralized enforcement of the policies provides the security, protection, privacy and sovereignty of digital assets throughout the ecosystem, regardless of whether a digital asset has been moved or duplicated or accessed and regardless of the type of digital asset (data, logic, software, etc.).

As discussed above, contract policies are utilized to define the rule for execution, access control and authorization of service instances collaborating by using digital assets. In one example, this functionality can be generally managed by secure service mesh 402. Secure service mesh 402 can function to facilitate use of contract policies to connect the data that defines each service instance uniquely related to a participating entity, what data is allowed to be connected, what data is allowed to be curated, what data is allowed to be analyzed, etc.

In some examples, secure service mesh 402 includes attestation agent 404, access and authorization agent 406, service monitoring agent 408 and security monitoring agent 410. Secure service mesh 402 can include additional elements. Attestation agent 404 can function to provide continuous attestation services to digital asset execution service instances 412 and/or digital asset exchange service instances 414. Attestation agent 404 can be hardware, software or a combination of hardware and software.

Similarly, access and authorization agent 406 can provide continuous access control services and authorization services to digital asset execution service instances 412 and/or digital asset exchange service instances 414 based on information from smart contracts 416. Access and authorization agent 406 can be hardware, software or a combination of hardware and software. The services provided by attestation agent 404 and access and authorization agent 406 to digital asset execution service instances 412 and/or digital asset exchange service instances 414 can function to provide secure coordination and communications between service instances and digital assets within the ecosystem.

In one example, service monitoring agent 408 can monitor the operation and utilization of digital asset execution service instances 412 and/or digital asset exchange service instances 414 to allow secure service mesh 402 to determine whether the functionality provided by digital asset execution service instances 412 and/or digital asset exchange service instances 414 is consistent with the corresponding contract(s). Service monitoring agent 408 can monitor the status of one or more participating entities and/or digital assets and compare the status with the relevant terms/conditions of the smart contract. Service monitoring agent 408 can append monitoring results to distributed ledgers 418 as part of the monitoring functionality. Service monitoring agent 408 can be hardware, software or a combination thereof.

Similarly, security monitoring agent 410 can monitor security parameters and operation (access control, authentication, etc.) of digital asset execution service instances 412 and/or digital asset exchange service instances 414 to allow secure service mesh 402 to determine whether appropriate security protocols are functioning and being followed by components within the ecosystem. Security monitoring agent 410 can monitor the status of one or more participating entities and/or digital assets and compare the status with the relevant terms/conditions of the smart contract. Security monitoring agent 410 can append monitoring results to distributed ledgers 418 as part of the monitoring functionality. Security monitoring agent 418 can be hardware, software or a combination thereof.

In some examples, decentralized components of the ecosystem can continuously monitor the ecosystem, the service instances and components of the ecosystem. Rules of execution policies can be enforced based on the results of monitoring and changes to the state of the ecosystem can be stored on distributed ledgers 418. An invalid state (violation of a contract term/condition, failure of a participating entity or service instance, etc.) can result in a contract termination or in disconnecting service instances and digital assets from the ecosystem, for example.

Some of the monitoring provided by service monitoring agent 408 and by security monitoring agent 410 can relate to the termination of contracts. When a contract is completed and terminated as the result of complete performance by all associated participating entities, the components of secure service mesh 402 can function to execute any relevant clearance policies, which can include rules to identify a fulfilled contract and can trigger processes like billing, payment, dispute escalation, etc. Clearance policies can include de-federation of trust, de-orchestration of service instances, removal of digital assets, or removal of access to digital assets, (and possibly duplicates), etc.

In various examples, policy enforcement and policy decisions are based on the unique identification of service instances, digital assets, participating entities, contracts, offerings, etc. Policy enforcement and policy decisions within the decentralized ecosystem ensures that access to digital assets that are subject to contract terms ends with the termination of the contract. Contract terms can define regular termination as well as irregular termination (failed attestation as determined by attestation agent 404, for example).

In some examples, global policies can define general rules of attestation for all participating entities. In some situations of attestation failure, the ecosystem may terminate contracts and also remove a participating entity from the ecosystem or the ecosystem can provide indications of attestation failure to prompt a cure by one or more participating entities, or elements of the ecosystem can independently attempt to rectify the attestation failure.

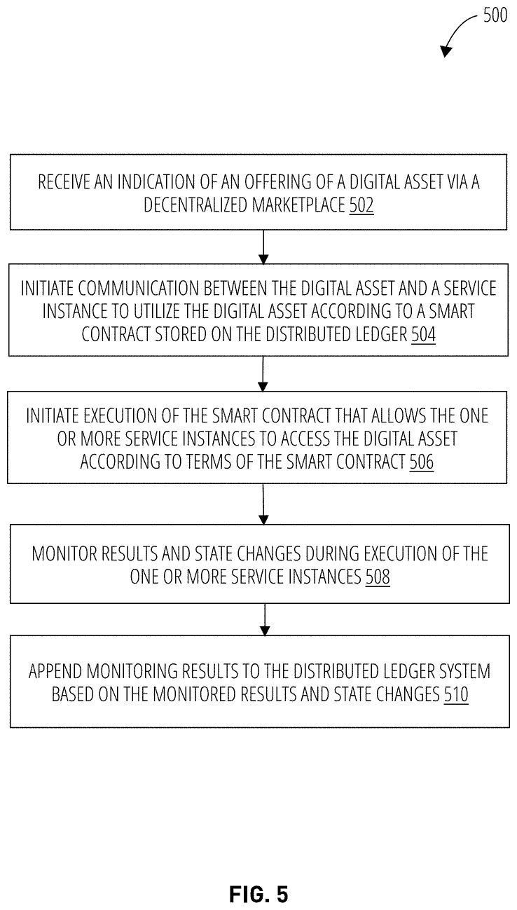

FIG. 5 is a flow diagram for one technique for managing decentralized ecosystem utilizing smart contracts. The functionality of flowchart 500 can be provided utilizing the architecture of FIG. 1, FIG. 2, FIG. 3 and/or FIG. 4, for example.

In block 502, a participating entity in the ecosystem can receive an indication of on offering of a digital asset via a decentralized marketplace, the offering having associated smart contract elements. The associated smart contract elements may be built upon one or more sub-contract templates. The offering can be part of a catalog of offerings or can be a stand alone offering in the decentralized marketplace.

In block 504, a participating entity in the ecosystem can initiate communication between the digital asset and one or more service instances, wherein the one or more service instances utilize the digital asset according to a smart contract stored on the distributed ledger, the smart contract comprising at least the smart contract elements. This can be accomplished utilizing an orchestration agent, for example. In one example, the smart contract is maintained utilizing distributed ledger technologies within the ecosystem.

In block 506, a participating entity in the ecosystem can initiate execution of the smart contract that allows the one or more service instances to access the digital asset according to terms of the smart contract. The service instances utilize the digital asset to participate in a swarm learning environment within the ecosystem, or for other distributed digital asset sharing/use purposes. As another example, the service instances can utilize the digital asset to train machine learning mechanisms. Other configurations can also be supported.

In block 508, a participating entity in the ecosystem can monitor results and state changes for the one or more service instances during execution of the smart contract. The monitoring can ensure that the terms of the smart contract are being followed. In some examples, the terms of the smart contract can be dynamically modifiable under pre-selected conditions and the monitoring process can function to ensure that the appropriate contract terms are applied and followed.

In block 510, a participating entity in the ecosystem can append monitoring results to the distributed ledger system based on the monitored results and state changes. The monitoring results can ensure accountability by securely and immutably persisting transactions in a decentralized manner using distributed ledger technologies (DLTs), which are blockchains, directed acyclic graphs (DAGs), hashgraphs, other types of distributed ledgers, etc. This can continue until execution of the smart contract is completed.

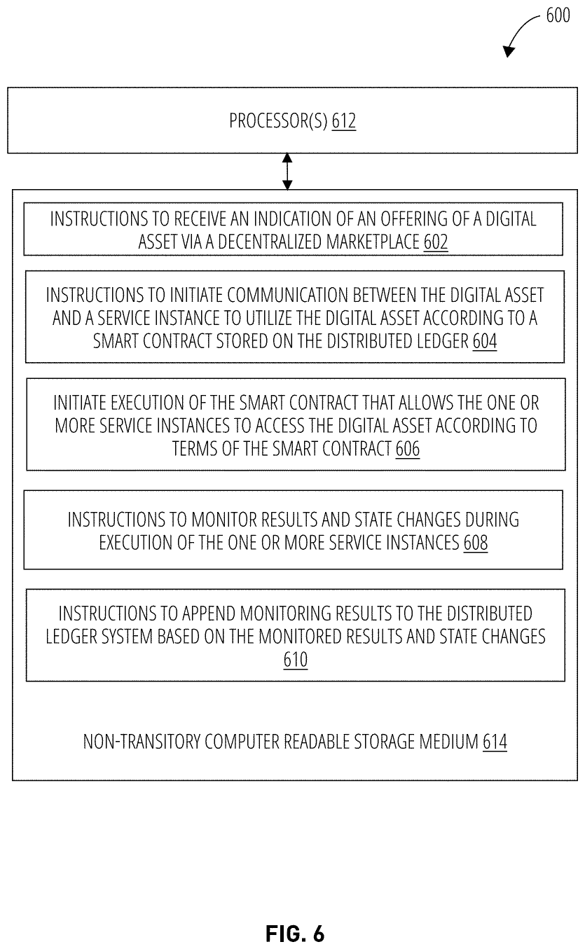

FIG. 6 is a block diagram of one example of a processing system that can manage decentralized ecosystem utilizing smart contracts. In an example, system 600 can include processor(s) 612 and non-transitory computer readable storage medium 614. Non-transitory computer readable storage medium 614 may store instructions 602, 604, 606, 608 and 610 that, when executed by processor(s) 612, cause processor(s) 612 to perform various functions. Examples of processor(s) 612 may include a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of a non-transitory computer readable storage medium 614 include tangible media such as random access memory (RAM), read-only memory (ROM), electrically erasable programmable read-only memory (EEPROM), flash memory, a hard disk drive, etc.

Instructions 602 cause processor(s) 612 to receive an indication of on offering of a digital asset via a decentralized marketplace, the offering having associated smart contract elements. The offering can have associated smart contract elements, which may be built upon one or more sub-contract templates. The offering can be part of a catalog of offerings or can be a stand alone offering.

Instructions 604 cause processor(s) 612 to orchestrate the digital asset with one or more service instances to allow the one or more service instances to utilize the digital asset according to a smart contract. This can be accomplished utilizing an orchestration agent, for example. In one example, the smart contract is maintained on one or more distributed ledgers within the ecosystem.

Instructions 606 cause processor(s) 612 to initiate execution of the smart contract that allows the one or more service instances to access the digital asset according to terms of the smart contract. In one example, the service instances utilize the digital asset to participate in a swarm learning environment within the ecosystem. In another example, the service instances can utilize the digital asset to train machine learning mechanisms. Other configurations can also be supported.

Instructions 608 cause processor(s) 612 to monitor results and state changes for the one or more service instances during execution of the smart contract. The monitoring can ensure that the terms of the smart contract are being followed. In some examples, the terms of the smart contract can be dynamically modifiable under pre-selected conditions and the monitoring process can function to ensure that the appropriate contract terms are applied and followed.

Instructions 610 cause processor(s) 612 to append monitoring results to the distributed ledger system based on the monitored results and state changes. This can continue until execution of the smart contract is completed.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, examples may also be downloaded as a computer program product, wherein the program may be transferred from a remote computer to a requesting computer. In some examples, non-transitory computer readable storage medium 614 have stored thereon data representing sequences of instructions that, when executed by processor(s) 612, cause processor(s) 612 to perform certain operations.

Linux is a family of open-source operating systems based on the Linux kernel available from the Free Software Foundation. Linux distributions include Debian, Fedora, Ubuntu, Red Hat Enterprise Linux, etc. Various trademarks listed herein are the property of the respective trademark owners. Kubernetes is an open-source container orchestration architecture for managing application deployment and management. Kubernetes can be utilized with container engines such as Docker (or other similar tools) to manage containers. Kubernetes is available from the Cloud Native Computing Foundation and Docker is a virtualization and container tool available from Docker, Inc. Alternative, non-Kubernetes embodiments can also be supported. Similarly, alternative, non-Docker embodiments can also be supported.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be combined with other examples. The various appearances of “an example,” “one example,” or “some examples” are not necessarily all referring to the same examples.

What is claimed is:

1. A system comprising:
a distributed ledger system;
an orchestration agent communicatively coupled with the distributed ledger, the orchestration agent configured to:
receive an indication of on offering of a digital asset via a decentralized marketplace, the offering having associated smart contract elements;
initiate communication between the digital asset and one or more service instances, wherein the one or more service instances utilize the digital asset according to a smart contract stored on the distributed ledger, the smart contract comprising at least the smart contract elements;
initiate execution of the smart contract allowing the one or more service instances access to the digital asset according to terms of the smart contract;
monitor results and state changes for the one or more service instances during execution of the smart contract; and
append monitoring results to the distributed ledger system based on the monitored results and state changes.

2. The system of claim 1 wherein the distributed ledger system comprises one or more of: a blockchain, a directed acyclic graph, a hashgraph, or a distributed ledger.

3. The system of claim 1 wherein the one or more service instances provide a swarm learning functionality.

4. The system of claim 1 wherein execution of the smart contract that allows the one or more service instances to access the digital asset according to terms of the smart contract comprises:
communicatively connecting the digital asset with at least one machine learning service instance; and
training the at least one machine learning service instance with data corresponding to the digital asset.

5. The system of claim 4 further wherein execution of the smart contract that allows the one or more service instances to access the digital asset according to terms of the smart contract comprises executing one or more clearance policies in response to completion of the smart contract terms.

6. The system of claim 1 wherein the smart contract is stored on the distributed ledger system.

7. A method comprising:
receiving an indication of an offering of a digital asset via a decentralized marketplace, the offering having associated smart contract elements;
orchestrating the digital asset with one or more service instances, wherein the service instances utilize the digital asset according to a smart contract comprising at least the smart contract elements within a decentralized ecosystem having a distributed ledger system;
initiating execution of the one or more service instances according to terms of the smart contract;
allowing access the digital asset according to terms of the smart contract by the one or more service instances by executing the smart contract;
monitoring results and state changes during execution of the one or more service instances;
appending monitoring results to the distributed ledger system based on the monitored results and state changes.

8. The method of claim 7 wherein the distributed ledger system comprises one or more of: a blockchain, a directed acyclic graph, a hashgraph, or a distributed ledger.

9. The method of claim 7 wherein the one or more service instances provide a swarm learning functionality.

10. The method of claim 7 wherein orchestrating the digital asset with the one or more service instances further comprises:
orchestrating the digital asset with at least one machine learning service instance; and
training the at least one machine learning service instance with data corresponding to the digital asset.

11. The method of claim 10 further wherein allowing access the digital asset according to terms of the smart contract by the one or more service instances by executing the smart contract comprises executing one or more clearance policies in response to completion of the smart contract terms.

12. The method of claim 7 wherein orchestrating the digital asset with the one or more service instances is controlled by contracted execution and negotiation operations between participating entities corresponding to the digital asset and the one or more service instances.

13. The method of claim 7 wherein the smart contract is stored on the distributed ledger system.

14. A non-transitory computer-readable storage medium having stored thereon instructions that, when executed by one or more processors, cause the one or more processors to:
offer a digital asset via a decentralized marketplace, the offering having associated smart contract elements;
orchestrate the digital asset with one or more service instances to utilize the digital asset according to a smart contract comprising at least the smart contract elements within a decentralized ecosystem having a distributed ledger system;
initiate execution of the one or more service instances according to terms of the smart contract;
allow access the digital asset according to terms of the smart contract by the one or more service instances by executing the smart contract;
monitor results and state changes during execution of the one or more service instances;
append monitoring results to the distributed ledger system based on the monitored results and state changes.

15. The non-transitory computer-readable storage medium of claim 14 wherein the distributed ledger system comprises one or more of: a blockchain, a directed acyclic graph, a hashgraph, or a distributed ledger.

16. The non-transitory computer-readable storage medium of claim 14 wherein the one or more service instances provide a swarm learning functionality.

17. The non-transitory computer-readable storage medium of claim 14 wherein the instructions further comprise instructions that, when executed by the one or more processors, cause the one or more processors to:
orchestrate the digital asset with at least one machine learning service instance; and
train the at least one machine learning service instance with data corresponding to the digital asset.

18. The non-transitory computer-readable storage medium of claim 17 wherein the instructions further comprise instructions that, when executed by the one or more processors, cause the one or more processors to execute one or more clearance policies in response to completion of the smart contract terms.

19. The non-transitory computer-readable storage medium of claim 14 wherein orchestrating the digital asset with the one or more service instances is controlled by contracted execution and negotiation operations between participating entities corresponding to the digital asset and the one or more service instances.

20. The non-transitory computer-readable storage medium of claim 14 wherein the smart contract is stored on the distributed ledger system.
